(19) United States
(12) Patent Application Publication
(10) Pub. No.: US 2011/0032414 A1
(43) Pub. Date: Feb. 10, 2011

(54) IMAGE PICKUP DEVICE AND CONTROL APPARATUS FOR THE SAME

(75) Inventors: Masato Sumiyoshi, Tokyo (JP); Nau Ozaki, Tokyo (JP); Masashi Jobashi, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/797,740

(22) Filed: Jun. 10, 2010

(30) Foreign Application Priority Data
Aug. 7, 2009 (JP) 2009-184958

(51) Int. Cl. H04N 5/238

(52) U.S. Cl. 348/367; 348/E05.04

(57) ABSTRACT

A digital camera that is an image pickup device includes: a sensor; a background portion movement speed calculating unit configured to calculate a movement speed of a background portion of a subject from a plurality of images picked up by the sensor; and a shutter speed calculating unit configured to calculate a shutter speed from the movement speed and a predetermined image flow quantity.

### CROSS-REFERENCE TO RELATED APPLICATION(S)

This application is based upon and claims the benefit of priority from the prior Japanese Patent Application No. 2009-184958, filed in Japan on Aug. 7, 2009; the entire contents of which are incorporated herein by reference.

### BACKGROUND

1. Field

The present invention relates to an image pickup device, and a control apparatus for the image pickup device and a storage medium. In particular, the present invention relates to an image pickup device that enables panning, and a control apparatus for such an image pickup device and a storage medium.

2. Description of the Related Art

Panning is a conventional technique in photography using a camera. The technique is a method in which a photographer pans a camera synchronously with a movement of a subject in a state where a shutter speed is set slower than normal in order to blur the background so as to emphasize a sense of speed of the subject.

Setting a shutter speed that obtains a sufficient panning effect may not be easy for the photographer that is a user. In consideration thereof, for example, Japanese Patent Application Laid-Open Publication No. 2000-194030 proposes a camera having a built-in angular velocity sensor and which determines a shutter speed using an output of the angular velocity sensor.

According to the proposal, when a panning mode is set, a flow speed of an image on a film plane is determined from an output of the angular velocity sensor, and a shutter speed is calculated from the determined flow speed and a predetermined flow quantity δ. Specifically, with a camera according to the proposal, a shutter speed τs (=δ/V=δ(ω×f)) is determined using an image flow velocity V (=ω×f) on a film plane calculated from an angular velocity ω of a camera tracking a moving subject that is a photographic target and a focal distance f of a photographic lens.

However, since the camera according to the proposal uses an angular velocity sensor, there is a problem in that capacity for accommodating the angular velocity sensor is required and cost increases accordingly.

Another problem exists regarding the accuracy of the angular velocity sensor. A low accuracy may result in an inconsistency between an image flow quantity calculated from an angular velocity outputted from the angular velocity sensor and an image flow quantity on an image pickup plane. There is also a problem in that a desired panning effect cannot be obtained when a measurement error is significant.

### BRIEF DESCRIPTION OF THE DRAWINGS

FIG. 1 is a configuration diagram illustrating a configuration of a digital camera according to a first embodiment of the present invention;

FIG. 2 is a flow chart illustrating an example of a flow of operations of a CPU 20 in a panning mode according to the first embodiment of the present invention;

FIG. 3 is a diagram for describing image pickup timings from a half way depressed state to a full depression;

FIG. 4 is a pre-image of image data IP(m−1) at a time T0 immediately preceding actual photography;

FIG. 5 is a pre-image of image data IPm at a time T1 immediately preceding actual photography;

FIG. 6 is a diagram for describing a difference between two pre-images;

FIG. 7 is a diagram illustrating an example of a histogram of motion vectors MV calculated per macro-block;

FIG. 8 is a diagram for describing an example in which a region 122 other than a region 121 at a central portion of a picked up image is set as a background portion;

FIG. 9 is a diagram for describing an example in which a region 124 other than a focus region 123 in a picked up image is set as a background portion; and

FIG. 10 is a flow chart illustrating an example of a flow of operations of a CPU 20 in a panning mode according to a second embodiment of the present invention.

### DETAILED DESCRIPTION

According to the embodiments, an image pickup device can be provided which includes: an image pickup element; a background portion movement speed calculating unit configured to calculate a movement speed of a background portion of a subject from a plurality of images picked up by the image pickup element; and a shutter speed calculating unit configured to calculate a shutter speed from the movement speed and a predetermined image flow quantity.

Hereinafter, embodiments will be described with reference to the drawings.

### First Embodiment

### Configuration

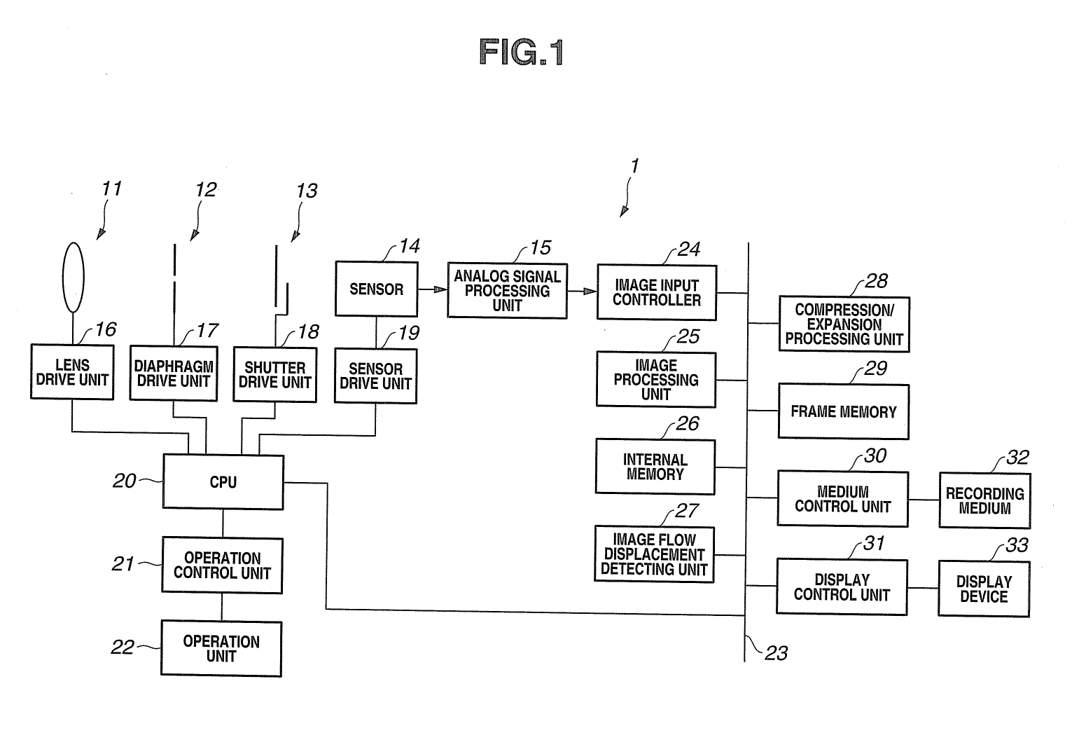

First, a configuration of an image pickup device according to a first embodiment of the present invention will be described with reference to FIG. 1. FIG. 1 is a configuration diagram illustrating a configuration of a digital camera according to the present embodiment.

As illustrated in FIG. 1, a digital camera 1 as an image pickup device is configured to include: a photographic lens 11; a diaphragm 12; a shutter 13; a sensor 14 that is an image sensor; an analog signal processing unit 15; a lens drive unit 16; a diaphragm drive unit 17; a shutter drive unit 18; a sensor drive unit 19; a CPU (central processing unit) 20; an operation control unit 21; an operation unit 22; a system bus 23; an image input controller 24; an image processing unit 25; an internal memory 26; an image flow displacement detecting unit 27; a compression/expansion processing unit 28; a frame memory 29; a medium control unit 30; a display control unit 31; a recording medium 32; and a display device 33. While an ordinary digital camera additionally includes elements such as a focus detecting element, processing units, and the like, descriptions thereof shall be omitted herein. Digital cameras include a single-lens reflex camera, a compact camera, a camera mounted on a mobile phone, and the like.

The CPU 20, the image input controller 24, the image processing unit 25, the internal memory 26, the image flow displacement detecting unit 27, the compression/expansion processing unit 28, the frame memory 29, the medium control unit 30, and the display control unit 31 are interconnected by the system bus 23. These circuits or software are included in one or more semiconductor devices and constitute an image pickup device control apparatus.

The operation unit 22 includes a release button, a power switch, a button group configured to set an exposure condition and/or a photography mode, and the like. The operation control unit 21 is a circuit configured so as to control an exchange of signals between the operation unit 22 and the CPU 20. The CPU 20 as a control unit outputs drive signals respectively to the lens drive unit 16, the diaphragm drive unit 17, the shutter drive unit 18, and the sensor drive unit 19, and according to a user instruction and various computation results, controls the photographic lens 11, the diaphragm 12, the shutter 13, and the sensor drive unit 19.

The lens 11 is made up of a focusing lens, a zoom lens, and the like and is controlled by the lens drive unit 16. The diaphragm 12 is driven by the diaphragm drive unit 17 made up of a motor driver or the like. The diaphragm drive unit 17 normally adjusts a diaphragm radius based on aperture data outputted from the image processing unit 25. The shutter 13 is driven by the shutter drive unit 18. The shutter drive unit 18 controls opening and closing of the shutter 13 based on a release signal generated by a depression of the release button and on shutter speed data outputted from the CPU 20. The release button is half way depressible and the operation control unit 21 is configured so as to be capable of detecting such a half way depressed state.

The CPU 20 generates shutter speed data based on data on automatic exposure and automatic white balance (AE/AWB) outputted from the image processing unit 25. As will be described later, when operating in a panning mode, a shutter speed τs (=δ/V) is determined from an image flow velocity V outputted by the image flow displacement detecting unit 27 and a preset image flow quantity δ.

As described above, the CPU 20 is also connected to the sensor drive unit 19 and outputs a drive signal to the sensor 14 that is an image pickup element such as a CCD or a CMOS. The sensor 14 outputs an accumulated charge as an analog signal. An analog signal outputted from the sensor 14 is inputted to the analog signal processing unit 15 and converted into digital image data. Digital image data from the analog signal processing unit 15 is supplied to the image input controller 24. The image input controller 24 writes image data inputted from the analog signal processing unit 15 into the frame memory 29.

Alternatively, a so-called electronic shutter configured to vary a charge accumulation time due to drive control of the sensor 14 can be used in place of the shutter 13, or the shutter 13 and an electronic shutter can be used concomitantly.

The frame memory 29 is a memory to be used when performing various digital signal processing on image data. The frame memory 29 is arranged so as to be capable of storing a plurality of pieces of image data. As will be described later, when the release button enters a half way depressed state, image data of a plurality of images consecutively picked up and obtained at a predetermined image pickup interval τp is stored in the frame memory 29, and an image flow velocity V that is a movement speed of a background portion is computed from data of two most recently stored images. When the release button is operated so as to be fully depressed, a shutter speed τs calculated from the image flow velocity V and an actual photography of the subject is executed. Image data of an image obtained by photography is stored in the frame memory 29.

The image processing unit 25 performs various digital signal processings on image data in the frame memory 29.

The internal memory 26 stores various constants to be set in the digital camera 1, programs to be executed by the CPU 20, and the like.

The image flow displacement detecting unit 27 calculates a displacement D of a background portion on an image pickup plane of the sensor 14 from two consecutive images stored in the frame memory 29, and generates an image flow velocity V (=D/τp) from an image pickup interval τp of the two images.

Moreover, while the image flow displacement detecting unit 27 is a circuit connected to the system bus 23 in FIG. 1, the image flow displacement detecting unit 27 may alternatively be configured by a hardware circuit or software in the image processing unit 25 or in the compression/expansion processing unit 28. In addition, the image flow displacement detecting unit 27 may be realized by utilizing a motion vector detection circuit to be used for video compression for a video photography function incorporated in the digital camera, or may be realized by software processing using the CPU 20.

The compression/expansion processing unit 28 performs compression on image data processed by the image processing unit 25 in a compression format such as JPEG to generate an image file. A tag storing supplementary information such as a date and time of photography is added to the image file according to an Exif format or the like. In addition, in a replay mode, the compression/expansion processing unit 28 reads out a compressed image file from the recording medium 32 to perform expansion.

The medium control unit 30 accesses the recording medium 32 and controls read and write of image files. The recording medium 32 is a recording medium that is attachable to and detachable from the digital camera 1. The recording medium 32 saves image data acquired by photography as image files.

The display control unit 31 is a control unit configured to cause the display device 33 that is a liquid crystal display apparatus or the like to display image data stored in the frame memory 29 as a so-called live view or to cause the display device 33 to display images stored in the recording medium 32. A live view is an image picked up by the sensor 14 at a predetermined time interval τ when a photography mode is selected and which is stored in the frame memory 29.

Therefore, a user is capable of operating the operation unit 22 of the digital camera 1 and setting a photography mode or the like to photograph a subject. In this case, a panning mode can be set as one of the photography modes. By setting the digital camera 1 to the panning mode and performing photography by panning the digital camera 1 synchronously with a movement of the subject, the user can obtain an image with an appropriate panning effect.

### (Operation)

Next, operations of the digital camera 1 will be described.

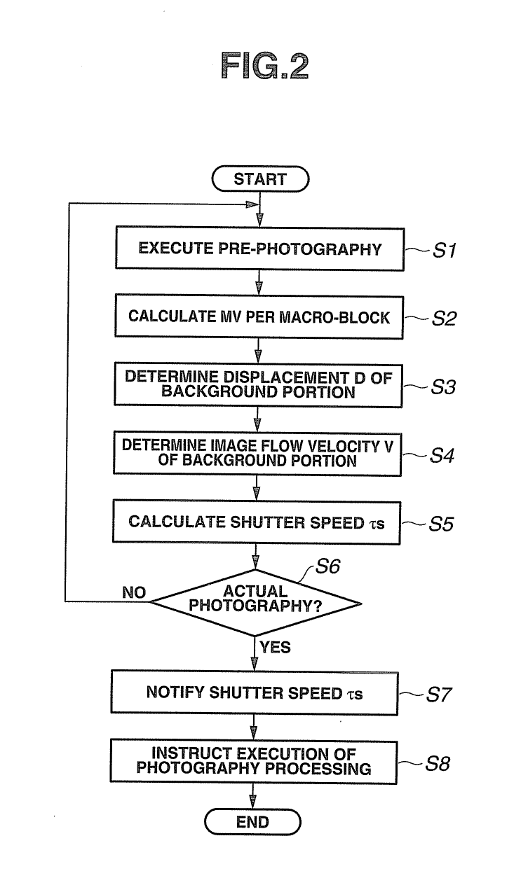

FIG. 2 is a flow chart illustrating an example of operations of the CPU 20 during the panning mode. The user operates the operation unit 22 of the camera to set the digital camera 1 to the panning mode. When the user half way depresses the release button in the panning mode, the CPU 20 executes processing illustrated in FIG. 2.

Actual photography is performed when the user, during a half way depressed state of the release button, operates the digital camera 1 so as to fully depress the release button at a desired timing while panning the digital camera 1 synchronously with a movement of the subject. In a case of a normal photography mode that is not the panning mode, during actual photography, the CPU 20 generates shutter speed data based on data on automatic exposure and automatic white balance (AE/AWB) outputted from the image processing unit 25.

As will be described later, in a case of the panning mode, the CPU 20 computes and determines a shutter speed τs (=δ/V) from an image flow velocity V of a background portion on an image pickup plane of the sensor 14 outputted by the image flow displacement detecting unit 27 and from a preset desired image flow quantity δ. The image flow quantity δ is set as, for example, the number of pixels on the image pickup plane of the sensor 14. The image flow velocity V of a background portion on the image pickup plane of the sensor 14 is calculated by the image flow displacement detecting unit 27. The image flow quantity δ is a quantity by which an image flows or, in other words, a quantity of a panning effect, and is a value either set by the user or set in advance as a specification of the digital camera 1.

In order to determine a shutter speed τs, the image flow displacement detecting unit 27 calculates a displacement D of a background portion from two consecutive pre-images stored in the frame memory 29, and generates an image flow velocity V (=D/τp) from a time interval τp of pre-photography. A pre-image is an image picked up in advance by the sensor 14 prior to actual photography.

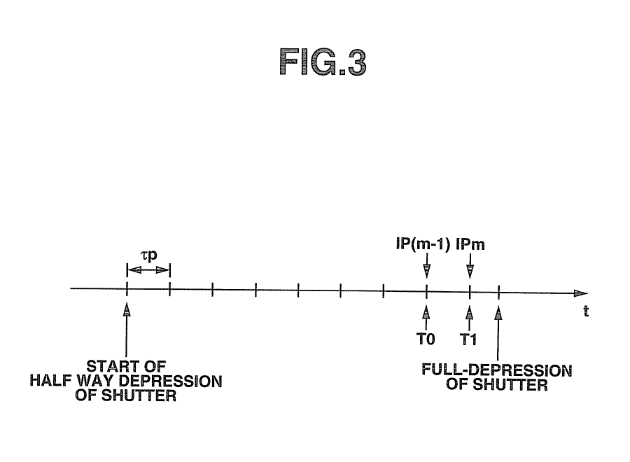

FIG. 3 is a diagram for describing image pickup timings from a half way depressed state to a full depression. As illustrated in FIG. 3, after a half way depressed state of the release button commences, the CPU 20 instructs the sensor 14 to consecutively perform photography at a predetermined time interval τp and store image data of pre-images in the frame memory 29 as long as the half way depressed state of the release button is maintained. As described above, a pre-image is an image picked up in advance by the sensor 14 prior to actual photography. Specifically, a pre-image is an image obtained immediately prior to performing photography of the subject when the CPU 20, having detected a half way depression signal generated when a half way depression operation is performed on the release button, causes the sensor 14 to execute pre-photography.

A resolution of a pre-image obtained in a half way depressed state of the release button may be set lower than a resolution of an image obtained by actual photography, to be saved in the frame memory 29.

Subsequently, when the release button is fully depressed or, in other words, deeply depressed by the user and an actual photography instruction is issued, a shutter speed τs is determined from a displacement D calculated from a plurality of pre-images stored in the frame memory 29 prior to actual photography, and actual photography is executed. For example, as illustrated in FIG. 3, a shutter speed τs is determined based on image data IP(m−1) and IPm corresponding to two frames at times T0 and T1 immediately prior to actual photography.

Returning now to FIG. 2, when the release button is half way depressed, the CPU 20 executes pre-photography (step S1). As described above, during pre-photography, photography is performed by the sensor 14 at a predetermined time interval τp and photographed image data is stored in the frame memory 29.

The CPU 20 causes the image flow displacement detecting unit 27 to calculate motion vectors MV for each macro-block from two most recent images stored in the frame memory 29 (step S2). In step S2, motion vectors MV are respectively obtained from a plurality of macro-blocks. When only a first piece of image data is available, a plurality of motion vectors MV is calculated after a second piece of image data is obtained.

Next, the CPU 20 causes the image flow displacement detecting unit 27 to determine a displacement D of the background portion (step S3). The displacement D of the background portion is a displacement of the background portion on the image pickup plane of the sensor 14. The displacement D is expressed in units of, for example, millimeters (mm). The displacement D is determined from a plurality of motion vectors MV calculated in step S2.

Being a two-dimensional quantity, a motion vector MV is changed to a one-dimensional displacement. For example, an average value MVav of magnitudes of all motion vectors MV is calculated and determined from all detected motion vectors MV, whereby the calculated and determined average value MVav is to be set as the displacement D of the background portion. Specifically, the image flow displacement detecting unit 27 calculates an average value of the magnitudes of a plurality of motion vectors MV obtained with respect to the background portion and, based on the calculated motion vector average value, calculates and determines the displacement D on the image pickup plane of the sensor 14. A method for determining the displacement D of the background portion will be described later.

Next, the CPU 20 causes the image flow displacement detecting unit 27 to determine a movement speed V of the background portion that is a displacement per unit of time (step S4). An image flow velocity V of the background portion is calculated and obtained by V=D/τp. In other words, in step S4, the image flow velocity V that is a movement speed of the background portion is calculated by dividing the displacement D by an image pickup time interval τp of two consecutive pre-images among a plurality of images. Step S4 constitutes a background portion movement speed calculating unit configured to calculate the image flow velocity V that is a movement speed of the background portion of a subject from a plurality of pre-images picked up by the sensor 14.

Subsequently, the CPU 20 calculates a shutter speed τs from the image flow velocity V determined by the image flow displacement detecting unit 27 and a preset image flow quantity δ (step S5). As described earlier, the image flow quantity δ is a value set by the user or stored in advance in the internal memory 26 of the digital camera 1, and is a value that enables a desired panning effect to be obtained. The shutter speed τs is calculated by τs=δ/V. In other words, step S5 constitutes a shutter speed calculating unit configured to calculate a shutter speed τs from an image flow velocity V that is a movement speed and a predetermined image flow quantity δ.

The CPU 20 judges whether or not an instruction for actual photography has been issued based on a full depression of the release button by the user. If an instruction for actual photography has not been issued, step S6 results in NO and processing returns to step S1. If an instruction for actual photography has been issued, step S6 results in YES, whereby the CPU 20 notifies the shutter speed is obtained in step S5 to the exposure control unit (not shown) that is either hardware or software (step S7), and instructs execution of photography processing (step S8). Actual photography is performed with a shutter speed set to τs, and under a condition of shutter-priority, upon determination of an aperture or the like. Consequently, step S8 constitutes a shutter control unit configured to control the shutter so that photography of a subject is performed by the sensor 14 at the shutter speed is calculated in step S5.

Moreover, while the shutter speed τs is arranged in the example described above as a shutter speed calculated and obtained from two pre-images obtained by pre-photography immediately prior to actual photography, an average value of a plurality of shutter speeds obtained from a pair of consecutive image data obtained during a pre-photography period may be calculated, whereby the average value may be set as a shutter speed during shutter-priority of actual photography. For example, while steps S1 to S6 are to be repeated during pre-photography, shutter speeds is calculated each time steps S1 to S6 are repeated may be stored. When an instruction for actual photography is issued, an average shutter speed τsav that is an average value of the stored plurality of shutter speeds τs may be calculated, whereby the average shutter speed τsav may be used as a shutter speed during shutter-priority of actual photography.

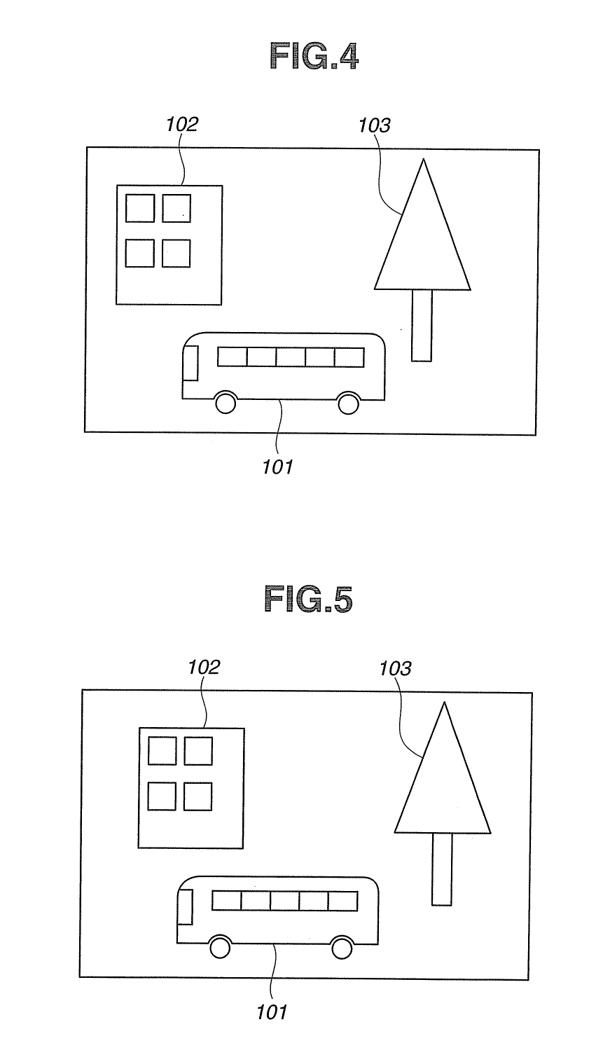

FIG. 4 and FIG. 5 are diagrams illustrating examples of two pre-images obtained immediately prior to actual photography during pre-photography. FIG. 4 is a pre-image of image data IP(m−1) at a time T0 immediately prior to actual photography, and FIG. 5 is a pre-image of image data IPm at a time T1 immediately prior to actual photography. Time T1 is a time at which time τp has elapsed from time T0.

In the panning mode, the user is panning the digital camera 1 synchronously with a subject 101 (in the diagrams, a bus is given as an example). Therefore, in FIG. 4 and FIG. 5, while positions of the subject 101 remains almost unchanged at the center of the screen, positions of objects 102 and 103 (in the diagrams, a building and a tree are given as examples) around the subject as well as other objects change in the screen.

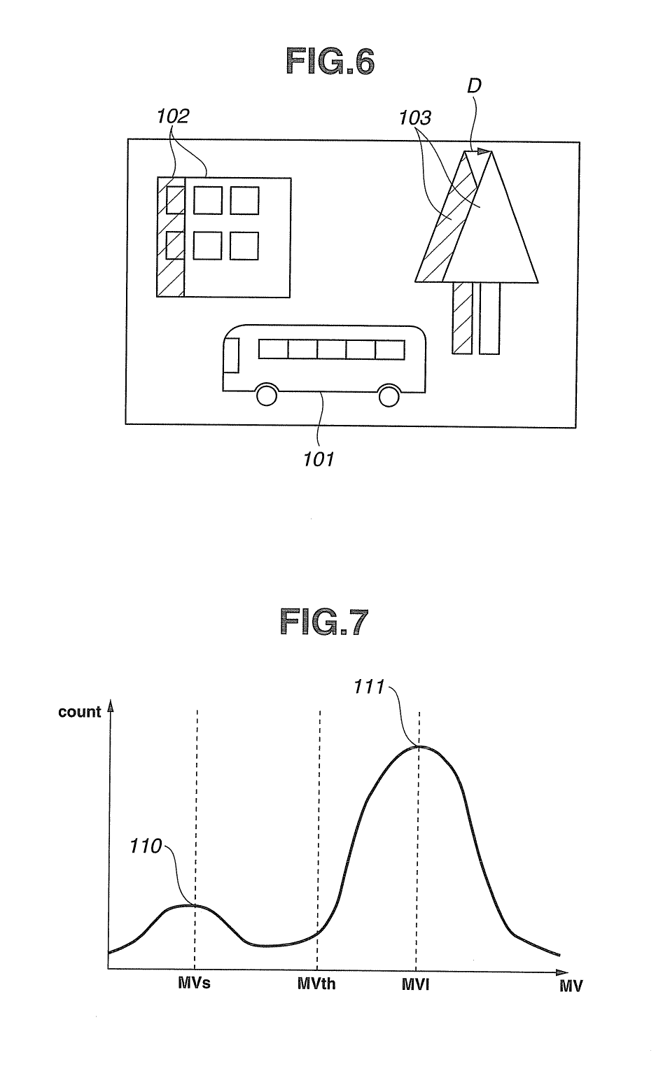

FIG. 6 is a diagram for describing a difference between two pre-images. As illustrated in FIG. 6, in the screen, the object 102 moves from a position indicated by hatchings in FIG. 4 to a position illustrated in FIG. 5 and the object 103 also moves from a position indicated by hatchings in FIG. 4 to a position illustrated in FIG. 5. On the other hand, since the digital camera 1 is panned synchronously with the movement of the subject 101, the subject 101 remains approximately stationary. The displacement D of the background portion is determined from two pre-images of a time interval τp of photography.

Next, a method of determining the displacement D of the background portion in step S3 will be described.

When determining the displacement D of the background portion in step S3 in FIG. 2, the image flow displacement detecting unit 27 calculates motion vectors MV per macro-block with respect to two pre-images, and calculates the displacement D of the background portion based on the plurality of calculated motion vectors MV. Therefore, the image flow displacement detecting unit 27 creates a histogram of motion vectors MV as illustrated in FIG. 7. FIG. 7 is a diagram illustrating an example of a histogram of motion vectors MV calculated per macro-block.

FIG. 7 is a histogram whose abscissa represents magnitude of the motion vectors MV and an ordinate represents a frequency (count) of the motion vectors MV.

In the case of panning, motion vectors MV of a subject portion including the subject 101 being tracked by the digital camera 1 characteristically decrease while motion vectors MV of a background portion not being tracked by the digital camera 1 such as the background objects 102 and 103 characteristically increase. Therefore, a distribution of the motion vectors MV takes a shape having two local maximum points 110 and 111 such as MVs and MV1 illustrated in FIG. 7. For example, the subject portion including the subject 101 takes a peaked motion vector distribution in which a value of the motion vector MV is smaller than other portions, while the background portion including the building 102 and the tree 103 takes a peaked motion vector distribution in which a value of the motion vector MV is greater than the object portions. The smaller distribution has a local maximum point MVs and the greater distribution has a local maximum point MV1, where MVs<MV1. In other words, the created histogram of the motion vectors MV takes the form of a peaked graph having two local maximum points.

Methods of discovering a local maximum point includes a method in which a local maximum point detected during a search while gradually increasing the value of the motion vector MV on the abscissa illustrated in FIG. 7 from a zero point is denoted by MVs while a local maximum point detected during a search while gradually decreasing the value of the motion vector MV from a maximum value of the motion vector MV is denoted by MV1. Using local maximum points MVs and MV1 obtained in this manner, a threshold MVth is set such that MVs<MVth<MV1. For example, an average value of MVs and MV1 may by set as MVth.

Moreover, the threshold Myth may be set with reference to the local maximum point MVs to a value in which a predetermined proportion is added on to MVs. For example, Mvth=coefficient×MVs, where the coefficient is 1.5.

Furthermore, an upper limit may be imposed on the threshold MVth. When a threshold determined as an average value of local maximum points MVs and MV1 or a value that is greater than the local maximum point MV1 by a predetermined proportion exceeds a predetermined upper limit, a limit may be imposed on the threshold Myth by setting the threshold MVth to the upper limit or the like.

The image flow displacement detecting unit 27 calculates an average value of motion vectors MV equal to or greater than the threshold MVth determined by the computation described above, and calculates the displacement D from the average value. Since the displacement D is a displacement on the image pickup plane of the sensor 14, the displacement D is calculated from the average value of motion vectors MV of the background portion using a predetermined formula.

Moreover, the displacement D may be calculated using a value of the local maximum point 111. This is because while a value of the motion vector MV1 at the local maximum point 111 is not an average value of the motion vectors MV of the background portion, the value represents a most frequent value.

In addition, when creating the histogram described above, necessary denoising may be performed such as eliminating abnormal data or performing smoothing of the graph in order to obtain an accurate histogram.

Furthermore, instead of creating a histogram such as that illustrated in FIG. 7, detection of motion vectors MV of a background portion may be performed by defining a region other than a region corresponding to a central portion of a picked up image as a background region, and detecting motion vectors MV in the region other than the central portion.

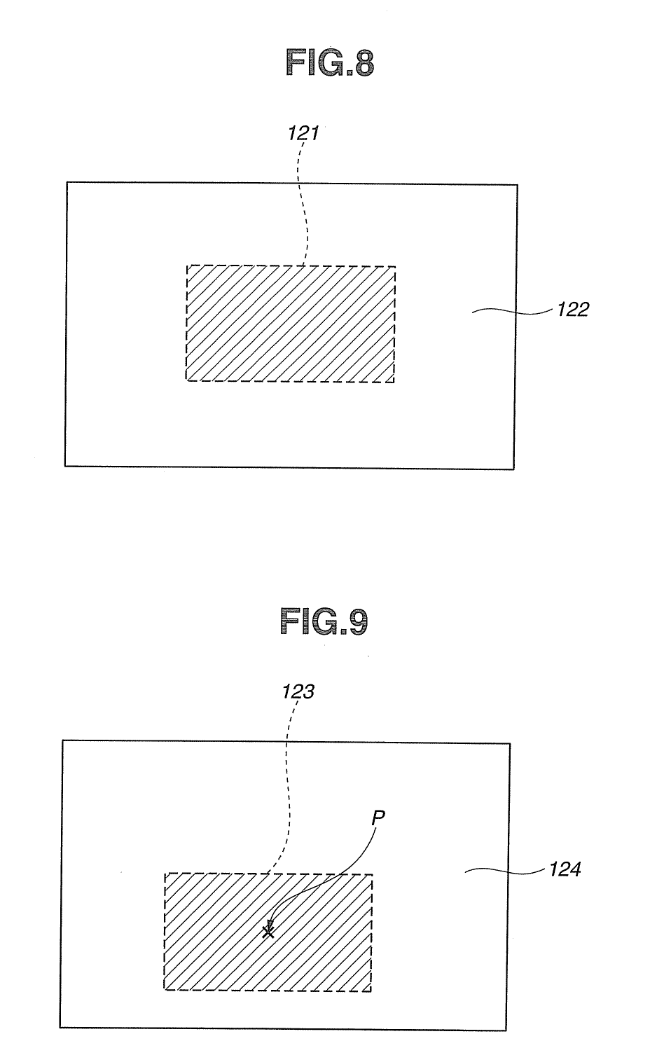

FIG. 8 is a diagram for describing an example in which a region 122 other than a region 121 (shaded) of a central portion of a picked up image is set as the background portion. As illustrated in FIG. 8, the region 122 other than the region 121 (shaded) corresponding to a central portion of an image having a predetermined size is set as the background portion and only motion vectors MV in the region 122 (unshaded) other than the region 121 are detected, whereby an average value or the like of magnitudes of the plurality of detected motion vectors MV is calculated and a displacement is calculated from the average value or the like.

In addition, instead of creating a histogram such as that illustrated in FIG. 7, detection of motion vectors MV of the background portion may be performed by defining a region from which a focus region detected by the digital camera 1 is removed as a background region, and detecting motion vectors in the region from which the focus region is removed.

FIG. 9 is a diagram for describing an example in which a region 124 other than a focus region 123 (shaded) in a picked up image is set as a background portion. As illustrated in FIG. 9, an in-focus point P in a picked up image is set as a center, the region 123 (shaded) having a predetermined size is set as a focus region, and a region 124 (unshaded) other than the region 123 is set as a background portion. Subsequently, only motion vectors MV in the region 124 other than the region 123 are detected, an average value or the like of magnitudes of the plurality of detected motion vectors MV is calculated, and a displacement is calculated from the average value or the like.

Moreover, a histogram of a plurality of motion vectors MV obtained with respect to regions 122 and 124 other than the central portion region 121 or the focus region 123 illustrated in FIG. 8 and FIG. 9 may be created, whereby a displacement may be determined as described above from a value of a local maximum point or an average value of motion vectors MV obtained from the histogram. The histogram in this case takes a motion vector distribution having a single peak and having MV1 illustrated in FIG. 7 as a local maximum point.

As described above, according to the present embodiment, an image pickup device and an image pickup device control apparatus capable of accurately setting an optimum shutter speed for panning without requiring an angular velocity sensor can be realized.

### Second Embodiment

While the image pickup device according to the first embodiment is arranged so that a desired panning effect can be obtained with respect to a background in a panning mode, when the skill of a photographer in regards to panning is insufficient, there may be cases where a subject itself that is not the background ends up being picked up as a blur.

In consideration thereof, an image pickup device according to the present embodiment is arranged such that a subject itself is not picked up with a blur that equals or exceeds a predetermined quantity during panning.

The image pickup device according to the second embodiment has a similar configuration to that of the image pickup device according to the first embodiment. Therefore, like components shall be denoted by like reference numerals and descriptions thereof shall be omitted, and only different components shall be primarily described. The configuration of the image pickup device according to the second embodiment is similar to that illustrated in FIG. 1.

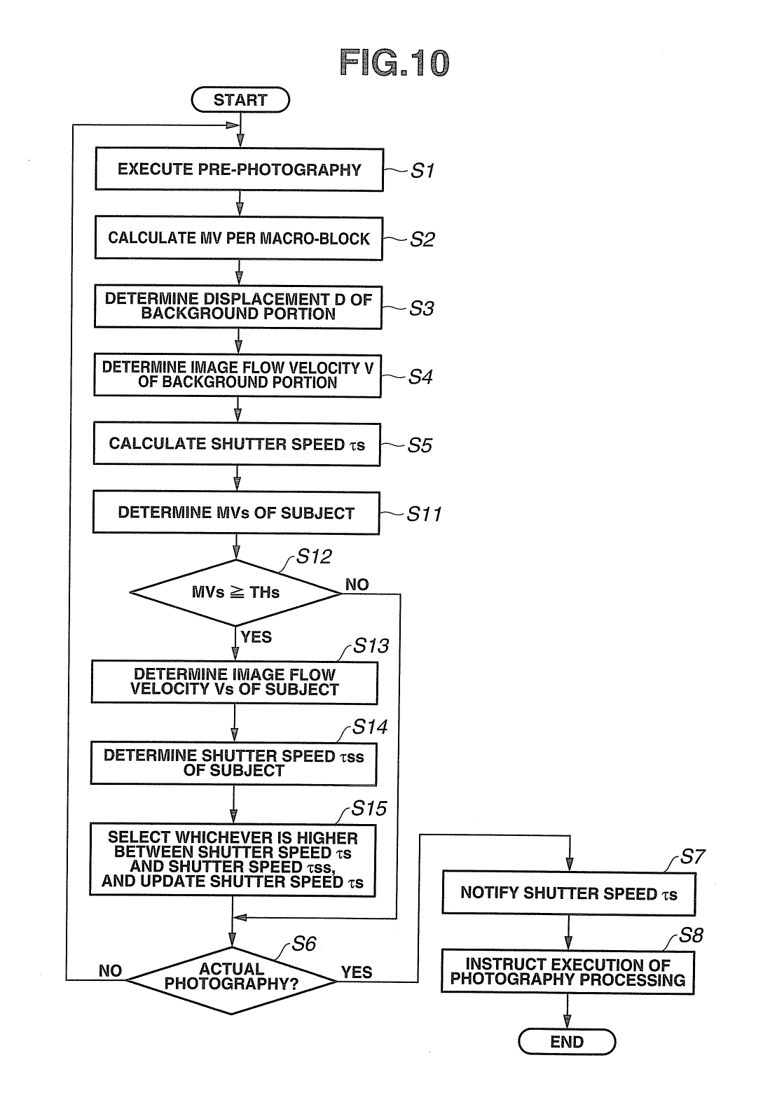

A digital camera as the image pickup device according to the second embodiment only differs from the first embodiment in contents of processing to be performed by the CPU 20. FIG. 10 is a flow chart illustrating an example of a flow of operations of the CPU 20 during a panning mode according to the present embodiment.

For example, in addition to operating the operation unit 22 and setting the digital camera 1 to the panning mode described in the first embodiment, when a setting for preventing a subject from blurring at or over a predetermined amount is enabled, the processing illustrated in FIG. 10 is executed. When the setting for preventing a subject from blurring at or over a predetermined amount is not enabled, the processing illustrated in FIG. 2 is executed.

In FIG. 10, contents of processing up to step S5 are similar to those of the processing illustrated in FIG. 2. Therefore, an optimum shutter speed for panning with respect to a background portion is calculated by step S5.

Subsequently, a motion vector MVs of a subject is calculated and determined (step S11). A method of calculating the motion vector MVs of the subject is the same as the method of calculating the motion vector of the background portion. For example, the motion vector MVs of the subject is a value of the local maximum point MVs of the histogram illustrated in FIG. 7, an average value of a plurality of motion vectors, or the like.

Next, a judgment is made on whether or not the motion vector MVs of the subject (for example, the local maximum point MVs of the histogram created when calculating the displacement D in step S3) is equal to or greater than a predetermined threshold THs (step S12). The threshold THs is a value of the motion vector MV corresponding to a permissible blur amount with respect to the subject. The threshold THs is, for example, a value of the motion vector MV corresponding to a predetermined amount Ds on the image pickup plane of the sensor 14. In other words, in cases where a local maximum point MVs of motion vectors MV with respect to the subject exceeds the threshold THs, the threshold THs is a value set in advance by the user or in the digital camera 1 on the understanding that the local maximum point MVs exceeding the threshold THs results in the subject being blurred at or over a predetermined amount Ds during panning.

When NO is judged in step S12 or, in other words, when the local maximum point MVs is lower than the threshold THs, the processing jumps to step S6. In this case, the processing is the same as the processing illustrated in FIG. 2.

However, when YES is judged in step S12 or, in other words, when the local maximum point MVs is equal to or greater than the threshold THs, an image flow velocity Vs of the subject is determined (step S13). The image flow velocity Vs of the subject is calculated by Vs=(MVs/τp).

Next, a shutter speed τss with respect to the subject is determined (step S14). The shutter speed τss is calculated in the same manner as in step S5 from a desired image flow quantity δs and the image flow velocity Vs of the subject. Specifically, τss is calculated by τss=(δs/Vs).

Subsequently, the CPU 20 compares the shutter speed τss calculated in step S14 with the shutter speed τs calculated in step S5, selects whichever is higher among the two shutter speeds, updates the shutter speed τs (step S15), and executes the processing of step S6.

More specifically, when the CPU 20 judges from information on the motion vector MV of the subject that the subject is to blur at or over a predetermined amount Ds, the CPU 20 adjusts and sets a shutter speed so that actual photography is performed at a higher shutter speed among the shutter speed τs determined from the image flow velocity V of the background portion and the shutter speed τss calculated on the assumption that the subject is not to blur at or over a predetermined amount Ds. In other words, steps S11 to S15 constitute a shutter speed adjusting unit configured to adjust the shutter speed τs calculated in step S5 so that the subject does not blur at or over a predetermined amount when the motion vector MV of a subject portion is equal to or greater than a predetermined threshold THs.

Since photography is performed in step S8 at a shutter speed adjusted and set or, in other words, changed in this manner, although it is possible that an image photographed by actual photography may have a reduced panning effect as compared to the first embodiment, the subject itself is prevented from blurring at or over a permissible range.

According to the present embodiment, in addition to realizing an image pickup device and an image pickup device control apparatus capable of accurately setting an optimum shutter speed for panning without requiring an angular velocity sensor, a photographer can now perform panning such that a subject does not blur at or over a predetermined amount even if the photographer is not highly skilled in panning.

While the present embodiment is arranged so that the local maximum point MVs is to be compared with the threshold THs, an average value of motion vectors in a predetermined range including the local maximum point MVs may be used instead.

In addition, while the threshold THs is a threshold of the motion vectors MV, the threshold may alternatively be a threshold of displacements calculated from the motion vectors MV. In such a case, a displacement calculated from the motion vectors MV is to be compared with the threshold.

As described above, with the image pickup devices according to the first and second embodiments described above, an image pickup device and an image pickup device control apparatus capable of accurately setting an optimum shutter speed for panning without requiring an angular velocity sensor can be realized.

Moreover, when contents to be executed by the image flow displacement detecting unit 27 and the CPU 20 described above are to be realized by software, all of or a part of program codes of a program of the software is to be recorded or stored as a computer program product in a portable medium such as a flexible disk or a CD-ROM or in a storage medium such as a hard disk. Operations are to be entirely or partially executed when the program is read by a computer. Alternatively, all of or a part of the program codes may be distributed or provided via a communication network. A user can readily realize an image pickup device according to the present invention by downloading the program via the communication network and installing the same onto a computer, or by installing the program into the computer from a recording medium.

While certain embodiments have been described, these embodiments have been presented by way of example only, and are not intended to limit the scope of the inventions. Indeed, the novel device, apparatus and medium described herein may be embodied in a variety of other forms; furthermore, various omissions, substitutions and changes in the form of the device, apparatus and medium described herein may be made without departing from the spirit of the inventions. The accompanying claims and their equivalents are intended to cover such forms or modifications as would fall within the scope and spirit of the inventions.

What is claimed is:

1. An image pickup device comprising:
an image pickup element;
a background portion movement speed calculating unit configured to calculate a movement speed of a background portion of a subject from a plurality of images picked up by the image pickup element; and
a shutter speed calculating unit configured to calculate a shutter speed from the movement speed and a predetermined image flow quantity.

2. The image pickup device according to claim 1, further comprising
a release button, wherein
the plurality of images are images obtained upon an operation of the release button immediately prior to performing photography of the subject.

3. The image pickup device according to claim 1, wherein
the background portion movement speed calculating unit is configured to calculate a displacement of the background portion based on the plurality of motion vectors of the background portion and to calculate the movement speed from the calculated displacement.

4. The image pickup device according to claim 3, wherein
the background portion movement speed calculating unit is configured to create a histogram with respect to the plurality of motion vectors and to calculate the displacement using a value of a local maximum point or an average value of motion vectors of the background portion obtained from the histogram.

5. The image pickup device according to claim 3, wherein
the background portion movement speed calculating unit is configured to calculate the displacement using a value of a local maximum point or an average value of motion vectors in regions other than respective central portions or focus regions of the plurality of images.

6. The image pickup device according to claim 3, wherein
the background portion movement speed calculating unit is configured to calculate the movement speed by dividing the displacement by an image pickup time interval of two consecutive images among the plurality of images.

7. The image pickup device according to claim 1, further comprising
a shutter control unit configured to control the shutter so that photography of the subject is performed by the image pickup element at the calculated shutter speed.

8. The image pickup device according to claim 1, further comprising
a shutter speed adjusting unit configured to adjust the calculated shutter speed so that the subject does not blur at or over a predetermined amount when a motion vector or a displacement of the subject portion is equal to or greater than a predetermined threshold.

9. The image pickup device according to claim 8, further comprising
a shutter control unit configured to control the shutter so that photography of the subject is performed by the image pickup element at the adjusted shutter speed.

10. An image pickup device control apparatus comprising:
a movement speed calculating unit configured to calculate a movement speed of a background portion of a subject from a plurality of images picked up by an image pickup element; and
a shutter speed calculating unit configured to calculate a shutter speed from the movement speed and a predetermined image flow quantity.

11. The image pickup device control apparatus according to claim 10, wherein
the plurality of images are images obtained upon an operation of a release button immediately prior to performing photography of the subject.

12. The image pickup device control apparatus according to claim 10, wherein
the background portion movement speed calculating unit is configured to calculate a displacement of the background portion based on the plurality of motion vectors of the background portion and to calculate the movement speed from the calculated displacement.

13. The image pickup device control apparatus according to claim 12, wherein
the background portion movement speed calculating unit is configured to create a histogram with respect to the plurality of motion vectors and to calculate the displacement using a value of a local maximum point or an average value of motion vectors of the background portion obtained from the histogram.

14. The image pickup device control apparatus according to claim 12, wherein
the background portion movement speed calculating unit is configured to calculate the displacement using a value of a local maximum point or an average value of motion vectors in regions other than respective central portions or focus regions of the plurality of images.

15. The image pickup device control apparatus according to claim 12, wherein
the background portion movement speed calculating unit is configured to calculate the movement speed by dividing the displacement by an image pickup time interval of two consecutive images among the plurality of images.

16. The image pickup device control apparatus according to claim 10, further comprising
a shutter control unit configured to control the shutter so that photography of the subject is performed by the image pickup element at the calculated shutter speed.

17. The image pickup device control apparatus according to claim 10, further comprising
a shutter speed adjusting unit configured to adjust the calculated shutter speed so that the subject does not blur at or over a predetermined amount when a motion vector or a displacement of the subject portion is equal to or greater than a predetermined threshold.

18. The image pickup device control apparatus according to claim 17, further comprising
a shutter control unit configured to control the shutter so that photography of the subject is performed by the image pickup element at the adjusted shutter speed.

19. A computer-readable storage medium including a program, wherein
the program is configured to cause a computer to execute:
a background portion movement speed calculating function configured to calculate a movement speed of a background portion of a subject from a plurality of images picked up by an image pickup element; and
a shutter speed calculating function configured to calculate a shutter speed from the movement speed and a predetermined image flow quantity.

20. The storage medium according to claim 19, further causing the computer to execute
a shutter speed adjusting function configured to adjust the shutter speed calculated by the shutter speed calculating function so that the subject does not blur at or over a predetermined amount when a motion vector or a displacement of the subject portion is equal to or greater than a predetermined threshold.
